(19) United States
(12) Patent Application Publication
(10) Pub. No.: US 2024/0220996 A1
(43) Pub. Date: Jul. 4, 2024

(54) System and Method for Managing Leads at an Event

(71) Applicants: Brandon Wernli, Gilbert, AZ (US); Satish Baniya, Lehi, UT (US); Matt Cheek, South Jordan, UT (US)

(72) Inventors: Brandon Wernli, Gilbert, AZ (US); Satish Baniya, Lehi, UT (US); Matt Cheek, South Jordan, UT (US)

(21) Appl. No.: 16/937,410

(22) Filed: Jul. 23, 2020

Related U.S. Application Data
(60) Provisional application No. 62/877,820, filed on Jul. 23, 2019.

(51) Int. Cl. G06Q 30/00; G06N 5/04; G06N 20/00; G06Q 30/02

(52) U.S. Cl. CPC G06Q 30/01; G06N 5/04; G06N 20/00; G06Q 30/0203

(57) ABSTRACT

An event lead management system is provided with a back-end portal that receives information and a front-end portal on a mobile device that presents content to a user and includes an interactive event interface (IEI) that logs feedback from the user. AI determines the content provided to the user based on information from the back-end portal and the IEI. The IEI can be an attendee app interface and a vendor app interface. Methods for managing an event are also provided involving creating a database of attendee information on a back-end portal, providing a mobile app to a user that logs feedback from the user and presents real time customized information to the user based on the attendee information and the feedback. Attendee behavior is collected and a list of promising leads is automatically provided by comparing the attendee information and the attendee behavior to the criteria.

### CROSS REFERENCE TO RELATED APPLICATION

This application claims the benefit of prior-filed application No. 62/877,820 under 35 U.S.C. 119(e), the contents of which are hereby incorporated by reference.

### BACKGROUND OF THE INVENTION

### Field of the Invention

The present invention relates to the field of adaptive systems, and more particularly systems and methods which are adaptive to a human user input and/or a data environment, as well as applications for such systems and methods. More particularly, embodiments of the invention involve, for example, consumer electronics, personal computers, control systems, and professional assistance systems.

### Description of Related Art

At an event, there are three primary participants: (i.) an event organizer, that plans and organizes the event; (ii.) exhibitors, that showcase products, services, and/or promotions at one or more event booths; and (iii.) attendees, that attend the event. Presenters may submit publications and/or make live presentations at events. Also, event sponsors; advertisers; and/or exhibitors pay the event organizer to receive prominent advertising space on an event floor.

Exhibitors at events want to identify those attendees that are most likely to benefit from the exhibitors' goods or services. Attendees that may become exhibitors' customers are referred to as “leads”. Both exhibitors and attendees benefit from being able to match the needs of the attendees with the offerings of the exhibitors.

Event organizers mail, or an attendee may pick up on site, a badge with a barcode, magstripe, or RFID tag. Contained in that badge is attendee's information or a number that is then linked to a database where relevant data about the attendee may be stored. Each exhibitor scans the badge of an interested attendee access any stored information. Attendees or event organizers may make certain information available to exhibitors to connect attendees with the appropriate exhibitors. Such information may include but is not limited to: attendee's name and address; spending habits; income; email-id; region of residence; company name; business phone; fax number; web site; age; sex; and/or occupation, year over year registration data, CRM data, website analytics, survey response data, real-time feedback and other information that is known to those having skill in the art.

Event exhibitors work to tailor their display content to fit potential customers' needs, and attendees want an event experience that informs them of where to go to be able get the most out of a conference. Relevant information may include which sessions of an event to attend or which demonstrations (demos) to visit. Event organizers are challenged to provide attendees a personalized journey that is capable of pivoting to their evolving desires.

Frankly, most people are using antiquated methods when it comes to lead generation. Persona-based marketing, attendee registration and generic customer journeys are too hit-and-miss. And unreliable. The data are often non-qualitative, generic, random, and create a mountain of information too painful for any sales team to sift through.

Therefore, there is a need for an improved method and system to convert attendee info into lead info and to use attendee info to customize the attendees event experience.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

Ananian, John Allen, U.S. Pat. No. 7,013,290, Personalized Interactive Digital Catalog Profiling, 2006.

Ramnani et al., U.S. Patent Application 2014/00666044, Crowd-sourced Contact Information and Updating System . . . , 2014.

Smith et al., U.S. Pat. No. 8,103,445, Dynamic Map Rendering as a Function of a User Parameter, 2012.

Spivack et al., U.S. Pat. No. 8,438,124, System and Method of a Knowledge Management and Networking Environment, 2013.

Fan et al., U.S. Pat. No. 9,143,881, Providing Interactive Services to Enhance Information Presentation Experiences Using Wireless Technologies, 2015.

Curtis et al., JP Patent Application 2014/073831, System and Method for Obtaining Revenue Through Display of Hyper-Relevant Advertising on Moving Objects, 2017.,

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a system and method of managing an event.

It is an object of the invention to convert attendee information into lead information and to use attendee information to customize the attendees' event experience.

It is another object of the invention to provide more sales leads to attendees of an event.

It is another object of the invention to provide more reliably relevant lead generation.

It is another object of the invention to provide event attendees a personalized journey that is capable of pivoting to their evolving desires.

It is another object of the invention to create an attendee experience that learns and responds to real-tune behaviors.

It is another object of the invention to take advantage of AI-powered recommendations that guide attendees to the precise experience they desire most.

It is another object of the invention to increase hot leads by 200-400%.

It is another object of the invention to automate and streamline the lead qualification process and produce immediate personalized and actionable targeted campaigns.

It is another object of the invention to provide a simplified and integrated registration experience.

It is another object of the invention to allow attendees to provide “hand-raisers” during the registration process that can be noticed and acted upon immediately.

The above and other objects may be achieved using devices involving an event lead management system comprising a back-end portal that receives information from a customer and a front-end portal on a mobile device that presents content to a user. The front-end portal also includes an interactive event interface that receives feedback from the user. A machine learning engine determines the content that is provided to the user based on information from the back-end portal and information from the interactive event interface.

The back-end portal may be cloud-based, and the front-end portal and the interactive event interface can be provided as an app on the user's own mobile device. In a particular embodiment, both the front-end portal and the interactive event interface are a single app on the mobile device. The interactive event interface can be an attendee app interface (for attendees to an event) and a vendor app interface (for registered vendors or sponsors of an event). For attendees, the attendee app interface can present a personalized smart agenda to the user. The personalized smart agenda may adjust in real time based on the attendee's behavior. The attendee app interface may also prompt responses from the user and those responses can be used to adjust the personalized smart agenda.

The vendor app interface may scan an attendee via 1d, 2d, QRcode, NFC, or business card scanner. The vendor app interface may alternately or additionally receive information from the attendee app interface

The above and other objects may be achieved using methods for managing an event involving creating a database of attendee information on a back-end portal, providing a mobile app to a user that receives feedback from the user and presents real time customized information to the user based on the attendee information and the feedback. The back-end portal may be cloud based and can include criteria for promising sales leads. Attendee behavior at the event is collected and a list of promising leads is automatically provided by comparing the attendee information and the attendee behavior to the criteria. The promising lead list may be cleansed by removing any attendees with certain undesirable criteria, like if they are employees of the vendor or the direct competitor of the vendor.

For attendees, the real time customized information can be a smart agenda and/or vendor marketing materials. For vendors, the real time customized information can include when a promising sales lead is near to or approaching the vendor or can be attendee information based on scanning attendees 1d, 2d, QRcode, NFC, or a business card scanner. The method may include providing a vendor mobile app for vendors and an attendee mobile app for attendees. The vendor mobile app may be able to communicate with the attendee mobile app to exchange information.

The method may also include integrating with an existing marketing automation platform so that hot leads can be aligned to a marketing campaign for immediate follow up and/or an existing event registration platform or other solutions such as, but not limited to: RainFocus, ITN, Cvent, Marketo, Salesforce, and Leadature. Through their REST API integration with Zappier, dozens of other CRM and marketing automation platforms can be connected. Zappier becomes the portal to facilitate these integrations.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts an example of the artificial intelligence model used in connection with the present invention.

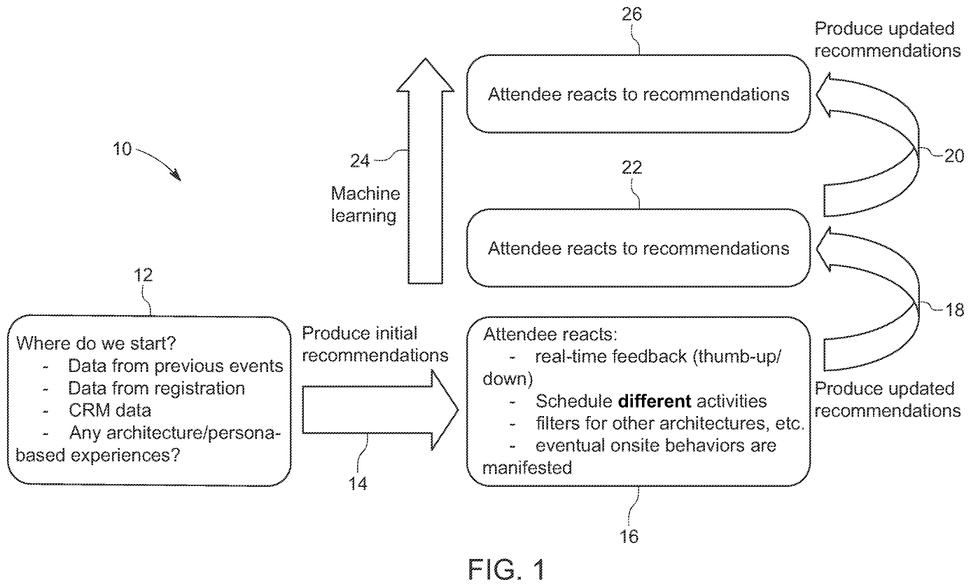

FIG. 2 depicts an example of the application architecture used in connection with the present invention.

FIG. 3 depicts a simple diagram of the back-end and front-end portals used in connection with the present invention.

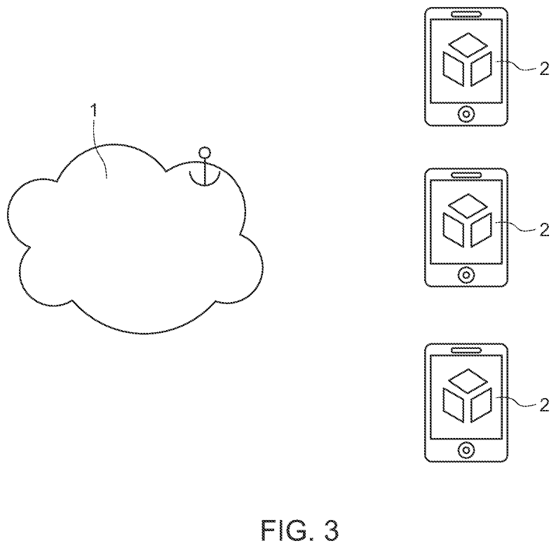

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

In one application of the invention, attendee information is converted into exhibitor leads. The system allows a customer to access a back-end portal 1 to configure various settings to the customer's account. For example, the back-end portal 1 may be used to: 1) add staff to obtain access to front-end lead 2 app, 2) determine lead qualifying questions to be asked in the front-end, 3) determine pre-scanned “hot lead” criteria or information to be screened out of consideration, 4) integrate with a marketing/CRM solution, or 5) configure auto-cleansing criteria. The portal may be cloud based, like, for example, Microsoft Azure.

The customer then allows various persons to download a front-end portal 2 application to a mobile device. The system of the invention may authenticate the user's mobile device through the application. The user is often a vendor who has registered to have an on-site presence at the event. Alternatively or additionally, users can be attendees of the event. Vendors using the front-end portal 2 will view a vendor interface app and attendees using the front-end portal 2 will view an attendee interface app. Vendors may wish to have information collected for event attendees. Attendees registering for an event can be asked for information including first name, last name, company name, job title, email, phone, address, city, state, zip, and country. Registering attendees can be asked to list additional information such as age, interests, reason for attending the event, kind of content the attendee is interested in, or other information. Vendors can determine questions or other information to request from registering attendees.

Every person attending an event can be a sales lead for a vendor and vendors will often scan attendees who stop to view the vendor's display, talk to a vendor representative, or otherwise learn more about a vendor's product or service. Once a user's device is authenticated, the vendor user is able to scan leads via 1d, 2d Qrcode, NFC or via business card scanner. In some embodiments, the attendee interface app will send information automatically to the vendor interface app based on, for example, physical proximity to the vendor, upon request by the vendor and/or upon request by the attendee. In another embodiment, the user is able to take a photo of the business card or event badge of an attendee and the photo will be appended to the record of that attendee. The photo can be scanned to read the attendees first name, last name, and job title, and the information on the badge may be digitized. The digitized information may be confirmed by an event employee to ensure accuracy. If desired, the user can book a one to one meeting with the attendee using iCal or any other calendar application or sending an email meeting invite.

The user may also choose to manually enter a lead or add a lead from their phone contacts. Lead information can include, for example, first name, last name, company name, job title, email, phone, address, city, state, zip, country, scan timestamp, event name. The application can display some data points for the lead to the vendor user including, for example, first name, last name, company name, or job title and transfer all information to the back-end portal. The back-end portal 1 may also include, for example, lead qualifying question responses, notes, GDPR opt-in, or a “hot lead” flag for attendees.

A “hot lead” may be designed by each customer or event vendor. In one embodiment, vendors registered to an event may download a mobile vendor application. “Hot lead” criteria can be entered and/or adjusted through the back-end portal 1 or by users on the front end portal 2. Each vendor has a pre-set default “hot lead” criteria and is able to keep, remove, or edit any “hot lead” criteria through the mobile app. If the “hot leads” application is configured, the user will be notified when an encountered lead has met the “hot lead” criterial. Additionally, the user may be able to edit a lead's details after the initial scan.

User's may also configure a “cleanse” filter. The cleanse filter will evaluate leads based on a pre-determined algorithm and will cleanse or remove leads that meet some undesirable criteria established by the algorithm. The algorithm can be a default algorithm or may be personalized to the user. A list of cleaned leads is automatically sent to the user's desired destination, frequently a marketing/CRM solution. The cleaned leads can be sent to the desired destination in real time. In an alternative embodiment, the user can opt to delay the push of lead data and opt for a manual push after the user has performed a manual review of curated leads, notes, and other details. This allows the user to filter or edit leads and add notes before manually pushing the leads to the desired end-destination.

The system of the invention can also collect event attendee data for the users and can provide an interactive event interface (IEI) for attendees. The IEI can be an application on an attendees' mobile device. The IEI can create a personalized smart agenda for the attendee that may include courses to attend, areas to visit, attendee networking resources and other recommendations based on the attendee's registration information and other available data for an attendee. Data is aggregated for a user from previous events, from event registration, CRM data, any known architecture/persona based experiences, and other information to produce initial even recommendations.

The smart agenda may then change based on the attendee's reaction to the smart agenda, and provide real-time recommendations for visiting the appropriate sessions, demos, exhibitors, attendees or other activities. The attendee can react to the initial recommendations by, for example, selecting a thumbs up/thumbs down indicator, scheduling different activities than those recommended, searching for other architectures, or manifesting other onsite behaviors. The IEI may also use location or location history of the attendee to determine delivery of marketing materials or event recommendations.

The system of the invention may include an analysis conducted post-event to confirm how persons behave when guided through a machine learning personalized journey. The system may alter future recommendations based on this analysis. Post-event sales activity can be used to monitor and report an ROI on lead generation strategy at events. Additionally or alternatively, an exhibitor may send follow up questions to attendees through an email or mobile app and receive attendee's answers through the same.

The IEI compiles all the necessary datapoints to produce a recommended journey for attendees that adjusts to their latest behavior or a last-second change of strategy. The system aggregates data from registration solutions, mobile apps, content tools, meetings management, database, APIs, custom development, BI, RFID, BLE, AR/VR (and more) to help align the attendees behavior to the event organizer's goals and objectives. A sound understanding of various data sources and how they interact is used to improve the way attendees interact with events through lead retrieval, registration, content schedule, attendee networking solutions, and more. The system can capture attendee behavior data to allow a customer to show, for example, vendors or sponsors, that more potential customers are being carefully guided to their exhibit booth because they know those potential leads have something they want.

The system may then automatically curate data and provide a report that cleanses less promising leads, reconciles multiple reports, and weeds out less important information. A list of promising leads of attendees can be generated and those attendees can be presented a marketing campaign for immediate follow up. A user or technician may receive potential event organizers' or exhibitors' information to understand event goals and KPIs. A technology stack may then be provided to the potential event organizer or exhibitor to meet their needs. The MLE can be integrated with existing platforms and help architect, configure and get the most out of existing infrastructure.

The system of the invention can take a user through a unified flow for building custom event websites and developing a registration process that is easy to configure and deploy. The system can be conveniently integrated with a variety of existing marketing automation and Salesforce platforms, which makes it easier to integrate into whatever platform organizers or exhibitors prefer.

Attendee information may be presented in real or delayed time to a vendor's mobile application whenever attendee texts information to exhibitor's short code. To deploy this solution, no additional hardware (besides one's mobile device) is needed onsite.

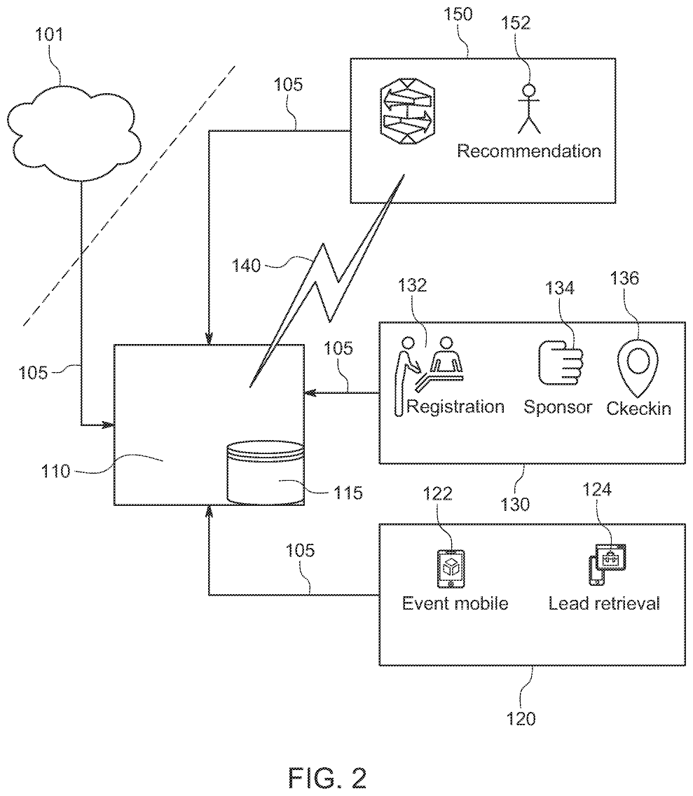

The system of the invention leverages REST API integrations with other solutions such as, but not limited to: RainFocus, ITN, Cvent, Marketo, Salesforce, and Leadature. Through their REST API integration with Zappier, dozens of other CRM and marketing automation platforms are connected to the system. Zappier becomes the portal to facilitate these integrations. FIG. 2 shows an example of the system's API architecture.

We claim:

1. An event lead management system comprising:
a back-end portal that receives information from a customer;
a front-end portal on a mobile device that presents content to a user;
an interactive event interface that receives feedback from the user;
a machine learning engine that determines the content that is provided to the user based on information from the back-end portal and information from the interactive event interface.

2. The system of claim 1 wherein at least one of the front-end portal and the interactive event interface is an app on the user's own mobile device.

3. The system of claim 1 wherein the back-end portal is cloud-based.

4. The system of claim 2, wherein the front-end portal and the interactive event interface are a single app on the mobile device.

5. The system of claim 1 wherein the interactive event interface is at least one of an attendee app interface and a vendor app interface.

6. The system of claim 5 wherein the attendee app interface presents a personalized smart agenda to the user.

7. The system of claim 6 wherein the personalized smart agenda adjusts in real time based on the user's behavior.

8. The system of claim 5 wherein the attendee app interface prompts responses from the user.

9. The system of claim 5 wherein the system includes both an attendee app interface and a vendor app interface and the vendor app interface is able to communicate user information to the vendor app interface

10. The system of claim 5 wherein the vendor app interface is able to scan an attendee to access the attendee's information.

11. A method of managing an event, comprising:
creating a database of attendee information on a back-end portal;
providing a mobile app to a user that receives feedback from the user and presents real time customized information to the user based on the attendee information and the feedback.

12. The method of claim 11 wherein the back-end portal is cloud based.

13. The method of claim 11 further comprising creating and saving criteria for promising sales leads via the back-end portal, collecting attendee behavior and automatically providing a list of promising leads based on comparing the attendee information and the attendee behavior to the criteria.

14. The method of claim 11 wherein the real time customized information is at least one of a smart agenda and vendor marketing materials.

15. The method of claim 11 further comprising creating and saving criteria for promising sales leads via the back-end portal and notifying the user when a promising sales lead is near to or approaching the user.

16. The method of claim 11 wherein the mobile app is able to scan leads via 1d, 2d, QRcode, NFC, or business card scanner.

17. The method of claim 11 wherein the user comprises a plurality of vendors and a plurality of attendees, and the mobile app comprises a vendor mobile app and an attendee mobile app.

18. The method of claim 17 wherein the vendor mobile app receives information from attendees mobile app.

19. The method of claim 13 wherein the criteria includes cleanse topics that may eliminate an attendee from consideration as a promising lead.

20. The method of claim 11 further comprising integrating with an existing marketing automation platform.
